(19) United States
(12) Patent Application Publication
(10) Pub. No.: US 2004/0244959 A1
(43) Pub. Date: Dec. 9, 2004

(54) Cooling fin structure and fin assembly

(76) Inventors: Chao-Nan Chien, Meishan Shiang (TW); Long-Song Shish, Taichung City (TW); Wei-Fang Wu, Taiping City (TW); Chin-Ming Chen, Taoyuan City (TW)

Correspondence Address: MARTINE & PENILLA, LLP, 710 LAKEWAY DRIVE, SUITE 170, SUNNYVALE, CA, 94085, US

(21) Appl. No.: 10/840,056

(22) Filed: May 5, 2004

(30) Foreign Application Priority Data
Jun. 5, 2003 (TW) 92115214

(51) Int. Cl. F28F 7/00; B23K 35/38; B23K 31/00; B23K 31/02; B23P 15/26

(52) U.S. Cl. 165/185; 165/905; 228/222; 29/890.054

(57) ABSTRACT

A cooling fin structure is constructed by a thermally conductive sheet bent to form a heat radiation part and a welding part. The welding part is formed with a vacant region, which is defined by notches, openings or a slot, and the thermally conductive sheet is welded to a substrate through the welding part.

### BACKGROUND OF THE INVENTION

(a). Field of the Invention

This invention relates to a cooling fin structure and a fin assembly and, more particularly, to a cooling fin structure and a fin assembly capable of reducing thermal contact resistance and maintaining stability in the welding process during fabrication.

(b). Description of the Related Art

Nowadays, the cooling fin is mostly manufactured through aluminum extruding. However, the fabricated cooling fin is limited in the ratio of its height to its thickness due to current performance of aluminum extruding, and thus its capacity of heat dissipation cannot be further improved. Under this circumstance, a welding process may replace the aluminum extruding process during the fabrication of a fin assembly so as to meet a high heat dissipation requirement for modern electronic devices.

FIG. 1A is a perspective view of a conventional cooling fin 102 used in the welding process. As shown in FIG. 1A, the cooling fin 102 with an L-shape cross-section is formed by a thermally conductive sheet bent to form a wide heat radiation part 102a and a thin welding part 102b. Referring to FIG. 1B, when each cooling fin 102 is welded to a substrate 104 and orderly arranged thereon, a fin assembly 100 manufactured by the welding process is formed.

During the welding process, in order to remove surface oxide and increase surface wetness, welding flux are often added on the welding area. However, when the welding process is finished, a large amount of the welding flux left on the welding area may worsen the welding quality and increase the thermal contact resistance between the cooling fin 102 and the substrate 104.

Referring to FIGS. 1B and 1C, because the cooling fins 102 affixed to the substrate 104 are combined to form the fin assembly 100 with their welding parts 102b being closely adjacent to each other, the squeezed welding flux underneath each welding part 102b is blocked by end surfaces of its adjacent welding parts (such as surface A-A shown in the diagram). Therefore, a large amount of the welding flux are left on the welding area between the cooling fin 102 and the substrate 104, thus considerably deteriorating the welding quality and increasing the thermal contact resistance between the cooling fin 102 and the substrate 104.

### SUMMARY OF THE INVENTION

An object of the invention is to provide a cooling fin structure and a fin assembly capable of reducing thermal contact resistance and maintaining the stability in the welding process during fabrication.

According to the invention, a cooling fin structure is constructed by a thermally conductive sheet bent to form a heat radiation part and a welding part. The welding part is formed with a vacant region, which is defined by notches, openings or a slot, and the thermally conductive sheet is welded to a substrate through the welding part.

Through the design of this invention, when each cooling fin is welded to a substrate, the vacant region on the welding part allows part of the surface area of the substrate not to be covered by the welding part between two adjacent fins can serve as an additional space on the substrate to accommodate the squeezed welding flux and the surplus solder. Hence, a large amount of the welding flux and surplus solder are removed from the welding area between the welding part and the substrate, thus improving the welding quality and decreasing the thermal contact resistance.

### BRIEF DESCRIPTION OF THE DRAWINGS

FIG. 1A is a perspective view of a conventional cooling fin.

FIG. 1B is a perspective view of a conventional fin assembly.

FIG. 1C is an enlarged partial plan view of FIG. 1B.

FIG. 2A is a perspective view of a cooling fin structure according to an embodiment of the invention.

FIG. 2B is a perspective view of a fin assembly according to an embodiment of the invention.

FIG. 2C is an enlarged partial plan view of FIG. 2B.

FIG. 3 is a perspective view of a cooling fin structure according to another embodiment of the invention.

FIG. 4 is a perspective view of a cooling fin structure according to another embodiment of the invention.

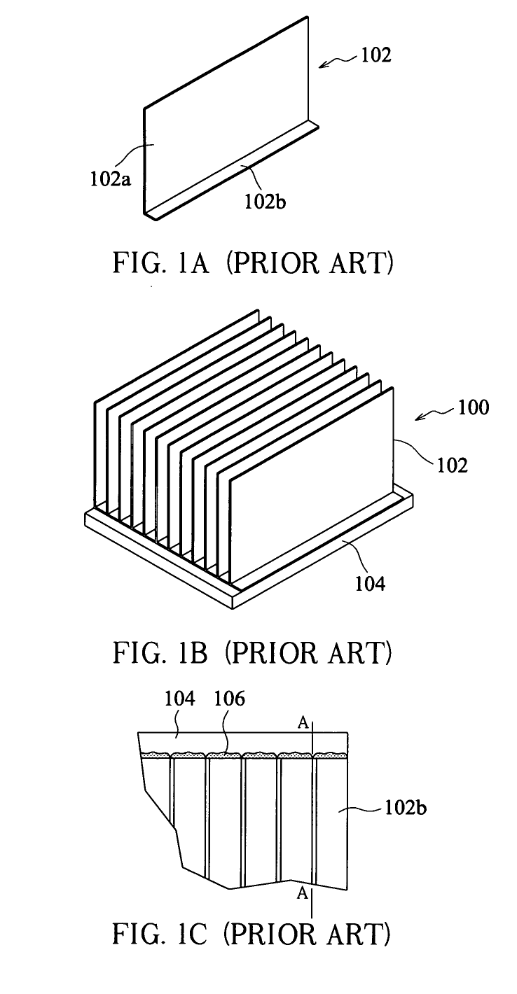

### DETAILED DESCRIPTION OF THE PREFERRED EMBODIMENTS

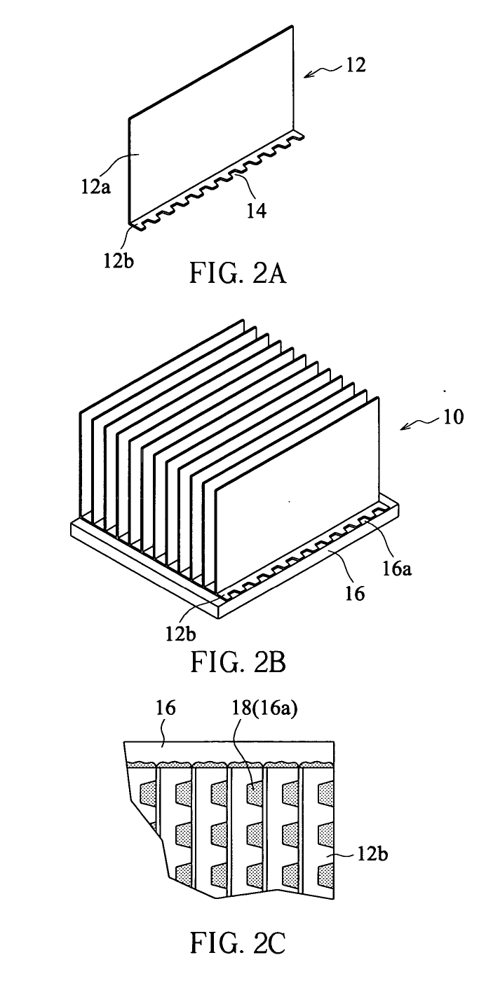

Referring to FIG. 2A, a cooling fin 12 with an L-shape cross-section is formed by a thermally conductive sheet bent to form a wide heat radiation part 12a and a thin welding part 12b. The thermally conductive sheet is bent through sheet metal work, and its materials may be aluminum, copper, aluminum alloy, copper alloy, or their compounds.

According to this embodiment, the welding part 12b is indented to form a row of notches 14, which cause the welding part 12b to have a serrate edge. The notches 14 can be in any shape, and the number of them is not limited. Referring to FIG. 2B, when each cooling fin 12 is welded to a substrate 16 and orderly arranged thereon, all the welding parts 12b cover one surface of the substrate 16, and part surface area 16a of the surface is not covered by the welding part 12b between two adjacent fins. The substrate 16 may be made of aluminum, copper, aluminum alloy, copper alloy or their compounds.

FIG. 2C is an enlarged partial plan view of FIG. 2B. Referring to FIG. 2C, because part surface are a 16a on the substrate 16 is not covered by the welding part 12b between two adjacent fins, they can serve as an additional space to accommodate the squeezed welding flux 18. In other words, when the cooling fin 12 is welded and pressed on the substrate 16, the welding flux 18 contained in a solder is squeezed from the welding area to the predefined areas 16a, so that most of the welding flux 18 is not left on the welding area between the welding part 12b and the substrate 16.

During the welding process, in order to remove surface oxide and increase surface wetness, welding flux is often added on the welding area. However, when the welding process is finished, a large amount of the welding flux left on the welding area may worsen the welding quality and increase the thermal contact resistance. For instance, a foaming operation is usually used in applying the welding flux on the welding area, and this may generate many bubbles inside the welding flux. In that case, when a large amount of the welding flux is left on the welding area, the bubbles with extremely low thermal conductivity can cause a considerable increase in the thermal contact resistance between the cooling fin and the substrate, and they also render the weld unsteady and thus worsen the welding quality. However, through the design of the invention, the welding flux 18 is almost removed from the welding area between the welding part 12b and the substrate 16, thus improving the welding quality and decreasing the thermal contact resistance.

Also, through the design of the invention, not only the welding flux left on the welding area but surplus solder is squeezed into the predefined area 16a; this reduces the thickness of the welding medium interposed between the cooling fin and the substrate and further decreases the thermal contact resistance as a result.

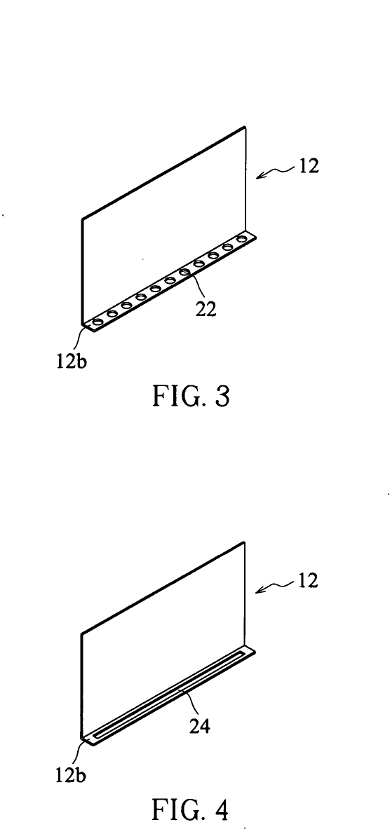

Referring to FIG. 3, the welding part 12b of the cooling fin 12 is formed with a plurality of openings 22 instead of notches. The shape of the opening 22 is not limited to a circular shape shown in FIG. 3 but can be in any shape, such as a polygon and an irregular shape, and the number of the openings is not restricted. Referring to FIG. 4, the welding part 12b of the cooling fin 12 is formed with a slot 24 instead of notches. From all such modifications, it can be understood that the welding part 12b is required only to provide a vacant region defined by the notches 14, the openings 22 or the slot 24, and that the shape, number and area of the vacant region is not limited. Thus, the vacant region can serve as an additional space on the substrate to accommodate the squeezed welding flux and the surplus solder.

Further, the L-shape cross-section of the thermally conductive sheet is for exemplary purpose only, and the way of bending the thermally conductive sheet is not limited. For example, the thermally conductive sheet may be bent to form a triangular cross-section, with its bottom portion being formed with the vacant region to act as the welding part.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A cooling fin structure, comprising:
a thermally conductive sheet bent to form a heat radiation part and a welding part, the welding part being formed with a vacant region, and the thermally conductive sheet being welded to a substrate through the welding part.

2. The cooling fin structure of claim 1, wherein the vacant region is defined by notches formed on an edge of the welding part.

3. The cooling fin structure of claim 1, wherein the welding part has a serrate edge.

4. The cooling fin structure of claim 1, wherein the vacant region is defined by openings formed on the welding part of the thermally conductive sheet.

5. The cooling fin structure of claim 4, wherein the openings are in a circular shape or a polygon shape.

6. The cooling fin structure of claim 1, wherein the vacant region is defined by a slot formed on the welding part of the thermally conductive sheet.

7. The cooling fin structure of claim 1, wherein the material of the thermally conductive sheet is selected from the group consisting of aluminum, copper, aluminum alloy, copper alloy, and their compounds.

8. The cooling fin structure of claim 1, wherein the material of the substrate is selected from the group consisting of aluminum, copper, aluminum alloy, copper alloy, and their compounds.

9. The cooling fin structure of claim 1, wherein the thermally conductive sheet is bent through sheet metal work.

10. The cooling fin structure of claim 1, wherein the thermally conductive sheet is bent to form an L-shape cross-section.

11. A fin assembly, comprising:
a substrate; and
a plurality of cooling fins, each of which is bent to form a heat radiation part and a welding part, the welding part being welded on a surface of the substrate to connect the cooling fins to the substrate;
wherein the welding part is formed with a vacant region such that part area of the surface of the substrate is not covered by the cooling fins.

12. The cooling fin structure of claim 11, wherein the cooling fin is bent through sheet metal work.

13. The cooling fin structure of claim 11, wherein the cooling fin is bent to form an L-shape cross-section.

14. The cooling fin structure of claim 11, wherein the vacant region is defined by notches formed on an edge of the welding part.

15. The cooling fin structure of claim 11, wherein the vacant region is defined by openings formed on the welding part.

16. The cooling fin structure of claim 15, wherein the openings are in a circular shape or a polygon shape.

17. The cooling fin structure of claim 11, wherein the vacant region is defined by a slot formed on the welding part.

18. The cooling fin structure of claim 11, wherein the thermally conductive material is selected from the group consisting of aluminum, copper, aluminum alloy, copper alloy, and their compounds.

19. The cooling fin structure of claim 11, wherein the material of the cooling fin is selected from the group consisting of aluminum, copper, aluminum alloy, copper alloy, and their compounds.
